(19) United States
(12) Patent Application Publication
(10) Pub. No.: US 2023/0260030 A1
(43) Pub. Date: Aug. 17, 2023

(54) MANAGING CARBON-LINKED SECURITIES AND LINKING CARBON OFFSETS WITH FINANCIAL PRODUCTS USING DISTRIBUTED COMPUTING SYSTEMS

(71) Applicants: Jean-Andre Corpuz, Clinton Corners, NY (US); Edward Loughran, Red Hook, NY (US); Peter Jacaruso, Westborough, MA (US); Michael Mueller, Weilheim (DE); Thorsten Peisl, Kitzbuehel (AT)

(72) Inventors: Jean-Andre Corpuz, Clinton Corners, NY (US); Edward Loughran, Red Hook, NY (US); Peter Jacaruso, Westborough, MA (US); Michael Mueller, Weilheim (DE); Thorsten Peisl, Kitzbuehel (AT)

(21) Appl. No.: 18/164,066

(22) Filed: Feb. 3, 2023

Related U.S. Application Data
(60) Provisional application No. 63/267,502, filed on Feb. 3, 2022.

(51) Int. Cl. G06Q 40/04

(52) U.S. Cl. CPC G06Q 40/04

(57) ABSTRACT

Methods, systems and devices for the creation, management and retirement of a carbon-linked security within a distributed ledger system. In an example, a method for administering at least one carbon-linked security product includes receiving a carbon footprint associated with an issuer and a confirmation of a deposit of an underlying security associated with the issuer, calculating a carbon offset amount from a ratio derived from at least the carbon footprint or an issuance of the underlying security, linking the carbon offset amount to the underlying security to create at least one carbon-linked security product, receiving a notification of a corporate action by the issuer, determining that the corporate action has an impact on the ratio, and automatically updating, based on the corporate action and the determining, the carbon offset amount in the distributed ledger.

### CROSS-REFERENCE TO RELATED APPLICATION

This application claims priority to U.S. Provisional Application 63/267,502 filed on Feb. 3, 2022, the disclosure of which is hereby incorporated by reference herein in its entirety.

### TECHNICAL FIELD

This document generally relates to carbon-linked securities, and more specifically, to linking carbon offsets with financial products using a distributed computing system.

### BACKGROUND

A carbon offset is a credit that a person or organization can obtain to decrease its carbon footprint. When the number of carbon offset credits obtained is equal to an individual or organization's carbon footprint, that person or organization is carbon-neutral. Revenue generated from the purchase of carbon offsets is often—but not always—invested in environmentally friendly projects, like investments in alternative energy and other “green” technologies.

Organizations and individuals pursue carbon offsetting voluntarily or to comply with regulations. An individual or company can pay a broker to purchase carbon offsets, often from projects in another part of the world. The customer calculates their emissions level, and the broker then charges a fee based on that level. Portions of the proceeds from the sale of offsets are often invested a in a project that reduces carbon emissions.

### SUMMARY

Embodiments of the disclosed technology are directed to linking financial securities to carbon offsets and/or carbon offset-based derivatives and the issuance of carbon-linked securities. In an example, the described embodiments include the calculation of ratios relating issuer's emissions and its fundamentals. Additionally, the proportions of the carbon-linked securities can be adjusted in the case of corporate actions. In another example, the disclosed technology provides workflows between appropriately permissioned members on a distributed computing system that issues and/or cancels the carbon-linked securities, as well as workflows for adjusting the carbon-linked securities based on corporate actions for either the underlying security and/or the carbon offset units. In yet another example, methods and systems for linking financial securities and carbon offsets, and the management of virtual receipts and/or carbon-linked securities on a distributed computing system are described.

In an example aspect, a method for administering at least one carbon-linked security product includes receiving a carbon footprint associated with an issuer and a confirmation of a deposit of an underlying security associated with the issuer, calculating a carbon offset amount from a ratio derived from at least the carbon footprint or an issuance of the underlying security, linking the carbon offset amount to the underlying security to create at least one carbon-linked security product, receiving a notification of a corporate action by the issuer, determining that the corporate action has an impact on the ratio, and automatically updating, based on the corporate action and the determining, the carbon offset amount in the distributed ledger.

In yet another example, the above-described method is embodied in the form of processor-executable code and stored in a computer-readable program medium.

In yet another example, a device that is configured or operable to perform the above-described method is disclosed.

The above examples and other aspects and their implementations are described in greater detail in the drawings, the descriptions, and the claims.

### BRIEF DESCRIPTION OF THE DRAWINGS

FIG. 1 shows an example of the various components that interact with the digital carbon registry for the management of carbon-linked securities and linking of carbon offsets with financial products using a distributed computing system.

FIG. 2 shows a block diagram of an example system's interactions between services related to the issuance and administration of carbon-linked securities in a distributed ledger.

FIG. 3 shows a block diagram of an example system's service types and the system's service interactions with elements of the network services.

FIG. 4 shows a block diagram for an example method for the issuance and cancellation mechanics of carbon-linked equities.

FIG. 5 shows a block diagram for an example method for issuance of carbon-linked securities, the exchange listing, immobilization, and security services.

FIG. 6 shows a block diagram for an example method for the issuance and cancellation of carbon offset fund units.

FIG. 7 shows a block diagram of an example method for the trading of a carbon-linked security.

FIG. 8 shows a block diagram for an example method for the cancellation of a carbon-linked security.

FIG. 9 shows an example operational systems process for the issuance of a carbon-linked security.

FIG. 10 shows an example calculation of a ratio using an issuer's fundamentals and carbon emission footprint for linking a carbon unit to a security.

FIG. 11 shows a flowchart for an example method for adjusting a carbon-linked security following corporate actions using the ratio.

FIG. 12 shows a process diagram of an example method for the adjustment of a third-party issued equity-based carbon-linked security.

FIG. 13 shows a process diagram of an example method for the adjustment of a corporate bond-based carbon-linked security.

FIG. 14 shows a process diagram of an example method for the adjustment of a third-party issued hybrid bond-based carbon-linked security.

FIG. 15 shows a process diagram of an example method for the adjustment of a corporate issued hybrid bond-based carbon-linked security.

FIG. 16 shows an example operational systems process for the administration of a carbon-linked security following a corporate action.

FIG. 17 is a flowchart of an example method for administering at least one carbon-linked security product.

FIG. 18 is a block diagram representation of a portion of an apparatus that may implement a method or technique described in this patent document.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Example headings for various sections below are used to facilitate the understanding of the disclosed subject matter and do not limit the scope of the claimed subject matter in any way. Accordingly, one or more features of one example section can be combined with one or more features of another example section.

### 1 Overview of Carbon-Linked Securities

Issuers (e.g., governments, state agencies, municipalities, public and private companies, special purpose investment vehicles, and the like), issue a wide variety of securities to raise money for many reasons. These issues can be in the form of equity, debt, hybrid securities, and derivatives. The proceeds are often used as operating capital or a specific project, and/or company-specific strategic investment. The purchasers of these securities, the investors, buy these financial instruments for a wide array of reasons that range from speculation to income, accepting the inherent risks involved with market movements. Over the last twenty years, there has been a growing trend in which investors have become more environmental, social and governance (ESG) conscientious and more ESG motivated in their investments and investment strategies. A large and growing percentage of investors have begun to consider more esoteric criteria that may or may not be directly related to the financial performance of their securities. Investors have become more aware and placed more importance on an issuer's environmental, social, and leadership impact. Increasingly, investors have taken their stance in investing in securities that share their views on these matters.

The term “carbon footprint” relates to the calculated or estimated carbon equivalent emissions. The term is becoming a common-place concept when speaking about countries, states, companies, and individuals. From international agreements to the Paris Agreement to state-mandated emission declaration requirements (e.g., California), individuals to companies to countries are not only being required to declare their carbon emissions, but they are also beginning to mandate reductions in their carbon footprint through a behavior change, and/or through the purchase of carbon offsets which are derived from projects or initiatives geared towards carbon reduction, absorption, and mitigation.

Carbon footprint or greenhouse gases (GHG) can be expressed as a carbon dioxide equivalent (CO₂-eq). Using CO₂-eq as a unit of measurement allows different GHGs to be compared on a like-for-like basis, relative to one unit of carbon dioxide. Aside from carbon dioxide, the two main GHGs and their 100-year global warming potential (GWP) are:
Methane (CH₄)—25×CO₂—releasing 1 kg of methane into the atmosphere is about equivalent to releasing 25 kg (0.025 T) of CO₂.
Nitrous oxide (N₂O)—298×CO₂—releasing 1 kg of nitrous oxide into the atmosphere is about equivalent to releasing 298 kg (0.298 T) of CO₂.

Carbon offsets and emissions data records exist on a wide array of so-called carbon registries, which for the most part use antiquated or challenging to use technologies, making identifying, finding, and purchasing carbon offsets tedious and often more time-consuming than they need to be. Although more and more carbon registries have sprung up in the last few years, it has not made the process less tedious.

Legislation is moving towards an increased reduction in carbon footprints. Companies are being required to reduce their overall emissions, often by purchasing offsets and/or directly investing in carbon projects, which requires additional capital. States and municipalities are seeing and being required to have a smaller carbon footprint for their infrastructure projects. Investors are also looking to make more conscientious investment decisions based on the issuer's carbon neutrality goals, or they can look to reduce their portfolio's carbon footprint by investing in carbon offsets. This can be difficult and requires a significant amount of time and research to understand and maintain a carbon offset portfolio that matches an investment portfolio. Even at the individual level, there is an increasing interest in seeking to reduce one's personal footprint through life choices ranging from using or switching to sustainable energy sources, to the increased use of less environmentally damaging modes of transportation, to simply buying carbon offsets. States, municipalities, companies, and investors have a need to become carbon neutral, a need to link carbon offsets to their securities whether they are raising money to fund a carbon project, buy carbon offsets, reduce the carbon footprint of a company, an infrastructure project, or a portfolio.

Carbon emissions are difficult to calculate, and the data can often be outdated, understated, or misleading. Legislation is being drawn up to change a lot of this. Issuers and investors can and will need to spend a lot of time to figure out how to ascertain not only the correct emissions footprint, but also how and how many units of offsets are required to make an investment security carbon neutral.

Furthermore, if a security is paired with a carbon offset to “carbon-neutralize” the security, it is difficult to adjust and/or maintain the desired level of carbon neutrality in case of corporate actions over time without a well-defined and easily executable process. Corporate actions, to name but a few, can include but are not limited to, acquisitions, dividends, stock splits, buy-backs, repurchases, tenders, exchanges, bankruptcies, takeovers, conversions, mergers, and spin-offs.

Therefore, a need exists in the field of responsible investing, for issuers to be able to issue carbon-linked securities. A further need exists for investors such that they may, in a simple manner, invest simultaneously in a financial security and its issuer's carbon footprint offset(s). A further need exists to have a methodology that incorporates an issuer's emissions, on a company or project level. Finally, there is also a need for a permissioned distributed system capable of creating and tracking carbon-linked units or securities in an immutable and resilient fashion.

### 1.1 Terminology

As referred to herein, the singular use of the term “issuer” may include “security issuer.” In some embodiments, its use can be used as a specific issue of a financial product of an issuer, e.g., an issuance of the bonds and the specifics of the bond.

As referred to herein, the term “fundamentals” may include metrics and capital structure data of such issuers. For example, information such as profitability, revenue, assets, liabilities, outstanding debt, and growth potential are considered fundamentals.

As referred to herein, the term “GHG emissions” may include a carbon footprint or carbon emissions. In some embodiments, the terms “carbon emissions,” “carbon footprint,” or “GHG emissions” may include the “carbon equivalent” of other gases, which may be expressed as the carbon dioxide equivalent (CO₂-eq). Using CO₂-eq as a unit of measurement allows different GHGs to be compared on a like-for-like basis, relative to one unit of carbon dioxide.

As referred to herein, the term “carbon emission footprint” may include a complete view of an issuer or an issuer's security of carbon emissions across three different “scopes” that include (1) direct emissions from owned or controlled sources, (2) indirect emissions from the generation of purchased electricity, steam, heating, and cooling consumed by the reporting company, and (3) all other indirect emissions that occur in a company's value chain. In an example, the carbon emission footprint can be represented in the form of CO₂ tonnage.

In some embodiments, the carbon emission footprint may be based on one or more of the three different scopes described above. In an example, a carbon-linked security may only include scope (3) such that the carbon emission footprint would be affected by any behavioral or corporate changes in the supply chain of the issuer, but not due to actions taken by the issuer itself, which would be encompassed by scope (1). In another example, only scopes (1) and (2) may be incorporated if the supply chain was to be explicitly excluded.

As referred to herein, the term “carbon unit” or “carbon offset” may include a reduction in GHG emissions—or an increase in carbon storage (e.g., through land restoration or tree planting)—that is used to compensate for emissions that occur elsewhere.

As referred to herein, the term “verification” may include “validation,” with these actions being applicable to carbon footprints, carbon emissions, and carbon offset projects.

### 2 Embodiments of the Disclosed Technology

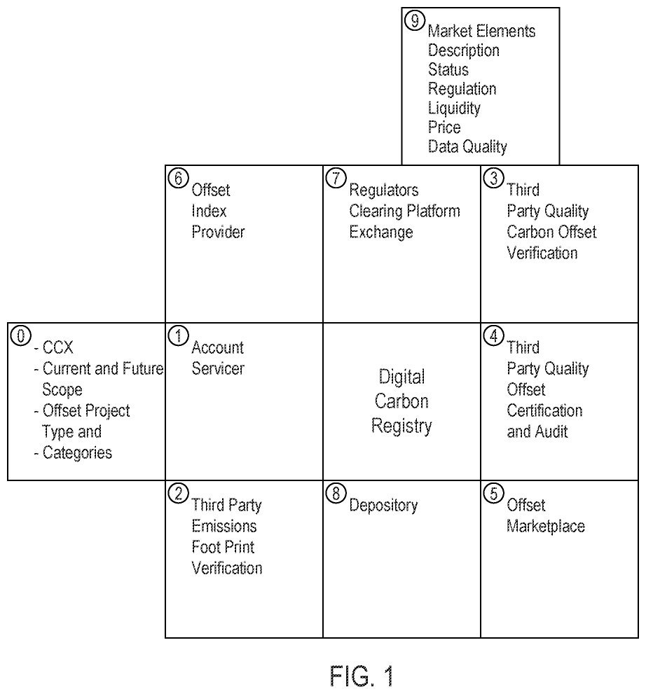

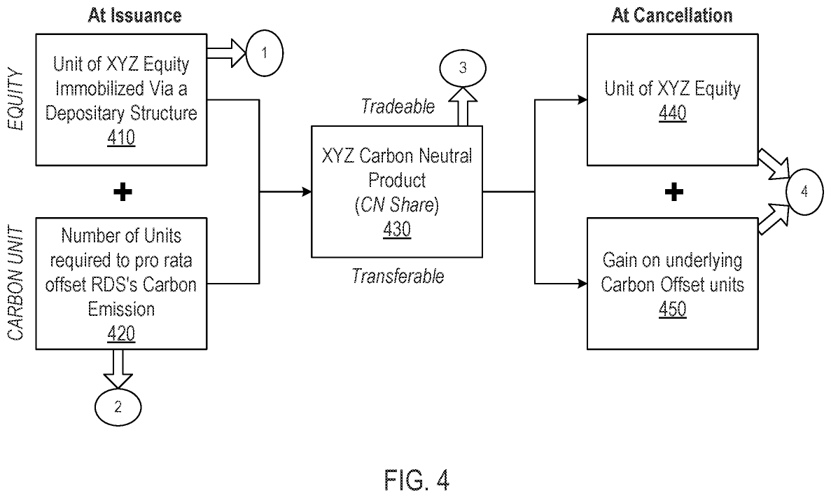

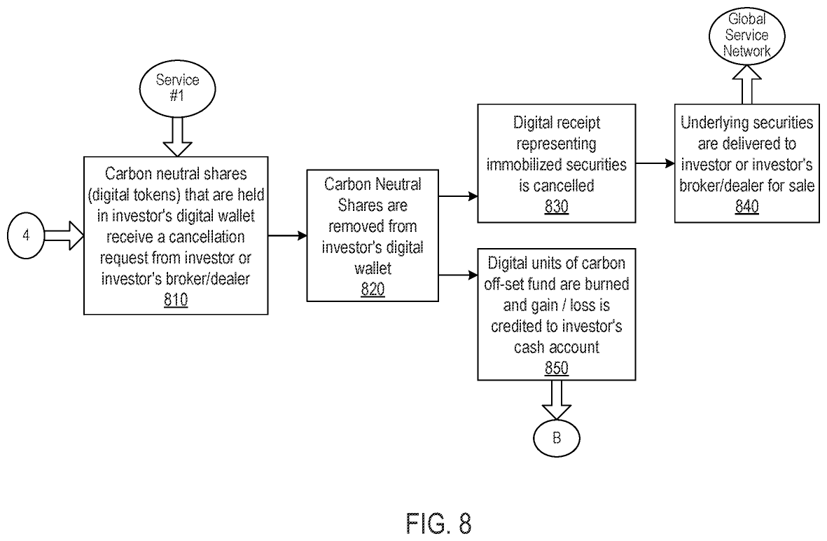

FIG. 1 shows all the entities, elements, or components that interact with the “digital carbon registry” (or distributed ledger), which include (0) data related to the carbon offset projects, (1) the account servicer, (2) the offset index provider, (3) third-party emissions footprint verification, (4) third-party carbon offset verification, (5) third-party quality offset certification and audit, (6) the offset marketplace, (7) regulator's clearing platform exchange, (8) the depository, and (9) market elements, which include liquidity, price, data quality, etc. These interactions advantageously achieve, amongst other benefits, the following outcomes:
Recording, certifying, and verifying a company, entity, or project carbon emissions footprint using GHG emission expressions.
Recording, certifying, and verifying an offset project's carbon reduction footprint using GHG emission expressions.
Implementing information flows for managing and issuing tokens for one or more carbon offset structures that both issue carbon offset tokens for “linking” and for destroying the carbon offset token in the event of a cancellation. FIG. 4 shows a block diagram for an example method for the issuance and cancellation mechanics of carbon-linked equities, and FIG. 8 shows a block diagram for an example method for the cancellation of a carbon-linked security.
Providing a depository service to immobilize underlying financial instruments and attach the required carbon offsets to create the carbon-neutral token, which is also referred to as the “linked financial instrument.” In an example, the depository service issues, cancels, and services all linked financial instrument transfers including corporate event services.
Issuing carbon-linked securities, the exchange listing, immobilization, and security services, as well as the trading of carbon-linked securities and a service to integrate with one or more exchanges for post-trade activities, including clearing, settlement, and custody services.

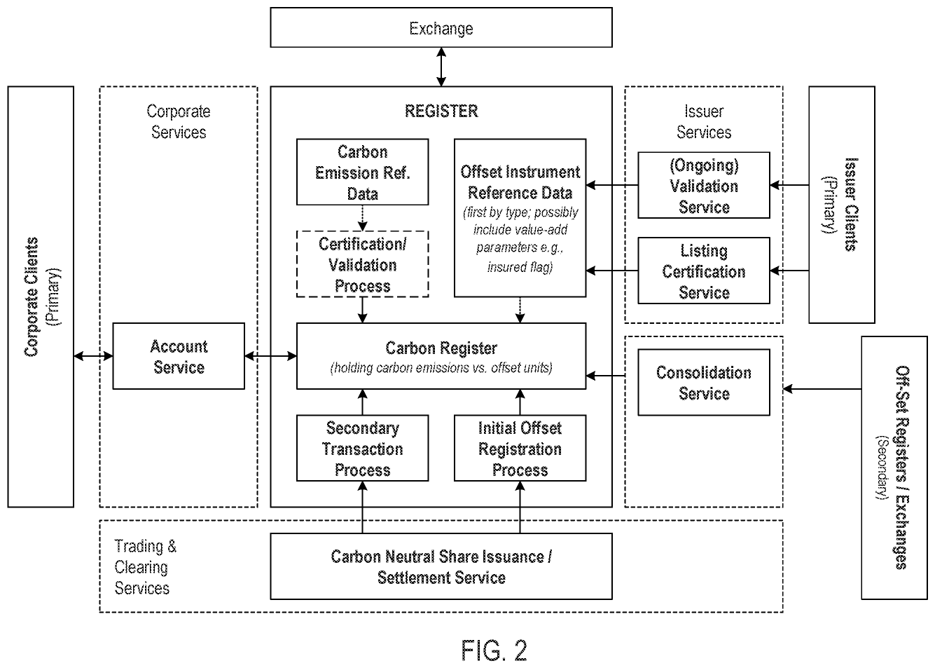

FIG. 2 shows a block diagram of an example system's interactions between services related to the issuance and administration of carbon-linked securities in a distributed ledger. As shown therein, the register interacts with corporate clients (through corporate services), the exchange, the issuer clients (through issuer services), offset registries and exchanges (through the consolidation service), and the carbon neutral share issuance and/or settlement service. The register is further configured to certify and validate carbon emission data.

2.1 Distributed Computing System

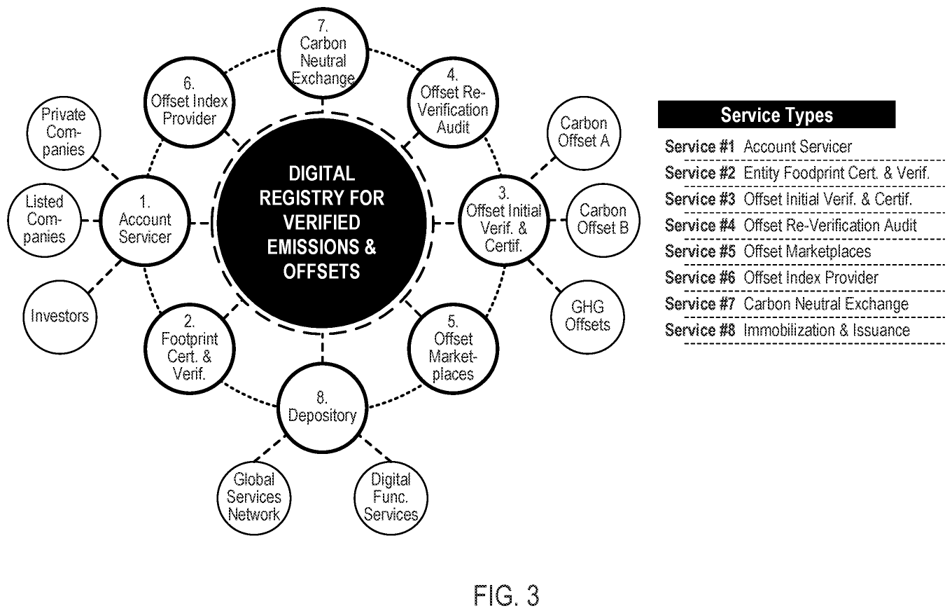

Embodiments of the disclosed technology include a distributed computing system that enables the interaction of the register with different types, thereby enabling the creation and management of carbon-linked securities and equities. FIG. 3 shows an example of the different service types and service interactions of the digital registry for verified emissions and offsets (e.g., the “register” in FIG. 2) with elements of the network service, and enables shared data management and transparency between members. As shown in FIG. 3, the various services that interact with the digital registry for verified emissions and offsets include:
Service #1: Account servicer
Service #2: Entity footprint certification and verification
Service #3: Offset initial verification and certification
Service #4: Offset re-verification audit
Service #5: Offset marketplaces
Service #6: Offset index provider
Service #7: Carbon neutral exchange
Service #8: Immobilization and issuance

In some embodiments, members of each of the different services and/or entities that interact with the digital carbon registry are permissioned to perform updates and according to their tasks. For example, a representative of the account servicer (Service #1) is authorized to open and maintain accounts, settle transactions, etc., whereas an individual working in third-party carbon offset re-verification (Service #4) might have read-only authorization for any transactional entries in the digital carbon registry, but has the ability to add (or attach) certifications, validations, or verifications to either the carbon offset amount or to one or more carbon offset projects that underly the carbon offset amount. More generally, the distributed computing system is configured to provide read/write access with high granularity, thereby enabling only permissioned members to access the appropriate portions of the digital registry.

FIGS. 4-8 show blocks diagrams for example methods for the issuance, trading, and cancellation of carbon-linked securities and equities, and highlights the interactions of the components of the distributed computing system that enable the creation and management of carbon-linked securities and equities.

FIG. 4 shows a block diagram for an example method for the issuance and cancellation mechanics of carbon-linked equities. As shown therein, issuance of the carbon-linked security includes determining a unit of an equity that is immobilized by the depository structure 410 and the number of carbon units required to offset the issuer's carbon emissions 420. These two quantities ((410) and (420)) are linked to create a tradeable carbon-linked security 430 that can be traded. Upon cancellation of the carbon-linked security, the unit of the equity 440 and the gain of the underlying carbon offset units 450 can be separated.

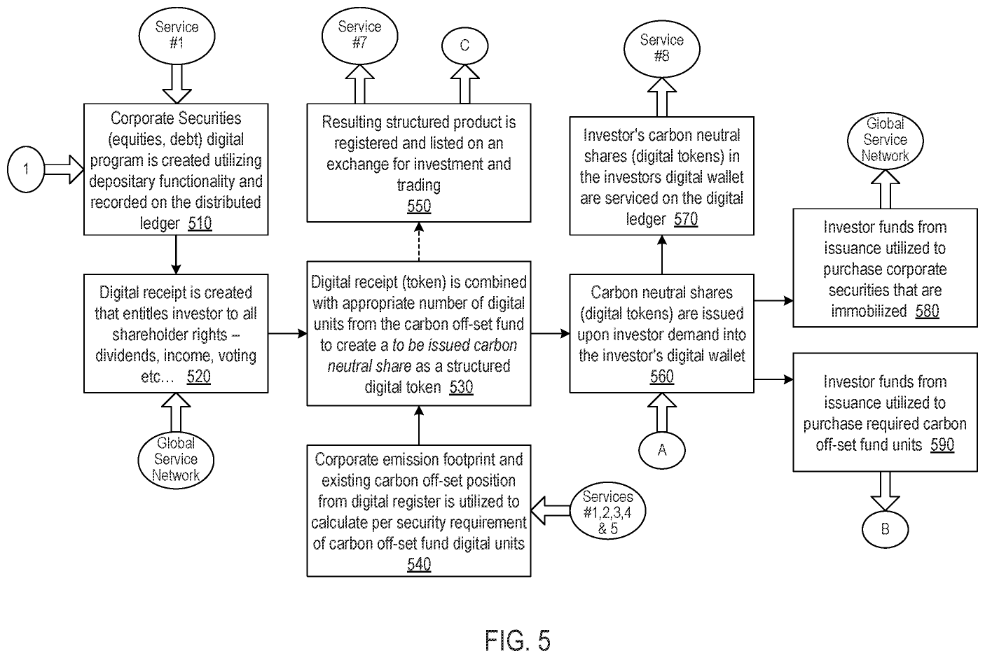

FIG. 5 shows a block diagram for an example system for issuance of carbon-linked securities, the exchange listing, immobilization, and security services. As shown therein, the unit of the equity that was immobilized by the depository structure (410) and input from the account servicer (Service #1 in FIG. 3) is used to create a corporate securities digital program utilizing depository functionality and recorded on the distributed ledger 510. A digital receipt is created, using input from a global services network, which entitles investors to all shareholder rights 520.

The account servicer, the entity footprint certification and verification, the offset initial verification and certification, the offset re-verification audit, and the offset marketplaces (Services #1-#5 in FIG. 3) interact to utilize the corporate emission footprint and existing carbon offset position from the digital register to calculate the per security requirement of carbon offset fund digital units 540. The per security requirement of carbon offset fund digital units (540) and the digital receipt (520) are combined to create a carbon neutral share (the carbon-linked security) as a structured digital token 530.

The resulting structured product (530) is registered and listed on the exchange for investment and trading 550, and also provided to the carbon neutral exchange (Service #7 in FIG. 3). Additionally, the carbon neutral shares (530) are issued upon investor demand into the investor's digital wallet 560. This is followed by the digital tokens corresponding to the carbon neutral shares in the investor's digital wallet being serviced on the digital ledger 570, and the investor funds from the issuance of the carbon neutral shares being used to purchase corporate securities that are immobilized 580 and to purchase the required carbon offset fund units 590.

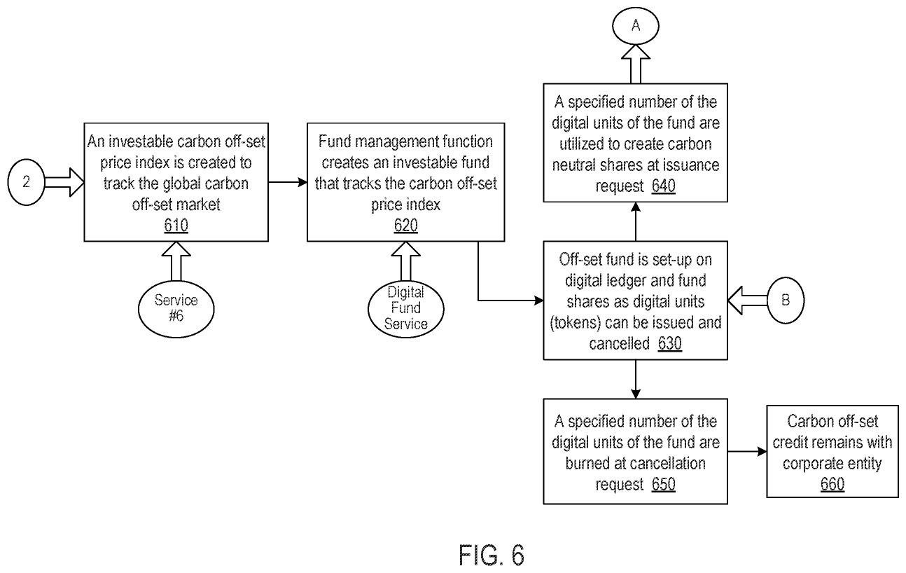

FIG. 6 shows a block diagram for an example system for the issuance and cancellation of carbon offset fund units. As shown therein, the number of carbon units required to offset the issuer's carbon emissions (420), and input from an offset index provider (Service #6 in FIG. 3), is used to create an investable carbon offset price index to track the global carbon offset market 610. The investable carbon offset price index (610) is tracked by an investable fund that is created by fund management functions 620. This is followed by an offset fund being setup on the digital ledger and fund shares as digital units (tokens) being issued and/or canceled 630 using the investor funds from the issuance of the carbon neutral shares (590).

A specified number of digital units of the fund (630) are used to create carbon neutral shares 640, which are the same carbon neutral shares that were issued into the investor's digital wallet (560). Alternatively, a specified number of digital units of the fund (630) are burned upon receiving a cancellation request 650, and the carbon offset credit remains with the corporate entity (or issuer) 660.

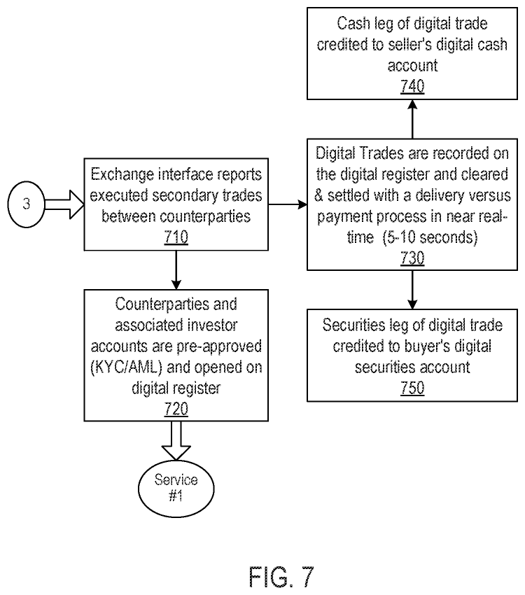

FIG. 7 shows a block diagram of an example system for the trading of a carbon-linked security. As shown therein, the tradeable carbon-linked security (430) can be traded between counterparties on the secondary market 710. Herein, the counterparties and associated investor accounts are pre-approved and opened on the digital register 720, and information thereof is sent to the account servicer (Service #1 in FIG. 3). The trades on the secondary market are recorded on the digital register, and cleared and settled with a delivery versus payment process in near real-time (e.g., 5 to 10 seconds) 730. The cash leg of the digital trade is then credited to the seller's digital cash account 740 and/or the securities leg of the digital trade is then credited to the seller's digital securities account 750.

FIG. 8 shows a block diagram for an example method for the cancellation of a carbon-linked security. As shown therein, a cancellation request is received for carbon neutral shares in an investor's digital wallet 810, which results in the separated unit of the equity (440) and gain of the underlying carbon offset units (450). The canceled carbon neutral shares are removed from the investor's digital wallet 820, which is followed by the digital receipt representing the immobilized securities being cancelled 830 and the underlying securities being delivered to the investor (or his/her broker/dealer) for sale, and/or the digital units of the carbon offset fund being burned, and gain/loss begin credited to the investor's cash account 840.

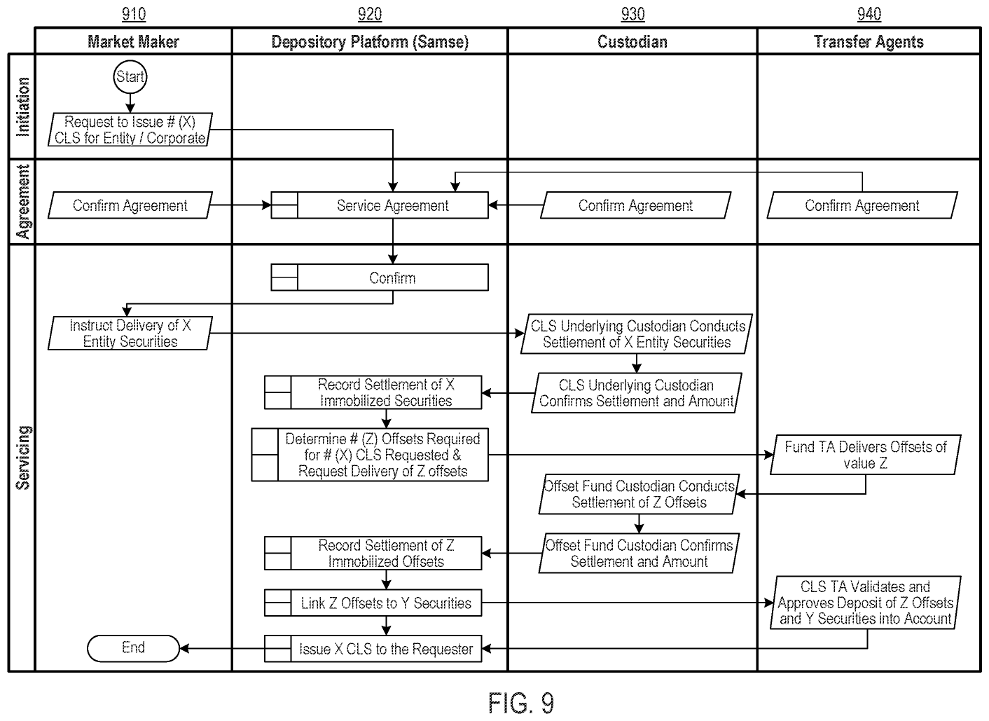

FIG. 9 shows an example operational systems process for the issuance of a carbon-linked security, according to embodiments of the disclosed technology. Therein, the various interactions between the market maker (or issuer) 1510, the depository platform 1520, the custodian 1530, and the transfer agent 1540, which result in the issuance of a carbon-linked security, are detailed.

As shown therein, the “Initiation” operation includes the market maker 910 requesting the issuance of a certain number of shares for an entity or corporation. This is followed by the “Agreement” operation, in which the market maker 910, the custodian (of the entity or corporation) 930, and the transfer agents 940 send a confirmation to the depository platform 920 that creates a service agreement. The remainder of the operational systems process is part of the “Servicing” operation. Herein, the depository platform 920 confirms the creation of the service agreement, and instructs the market maker 910 to deliver the certain number of shares, or more generally, the securities for the entity or corporation to the custodian 930. The custodian 930 performs settlement of the securities, and notifies the depository platform 920, which records the settlement and determines the carbon offset amount required for the securities and send a request for delivery of the carbon offset amount to the transfer agents 940. The transfer agents 940 delivers the carbon offset amount to the custodian 930 for settlement. The depository platform 920 records the settlement of the carbon offset amount and links the carbon offset amount to the securities, thereby creating the carbon-linked security. The carbon-linked security is then issued to the requester and send to the transfer agents 940 for validation and approval of the deposit of the carbon-linked security into an account.

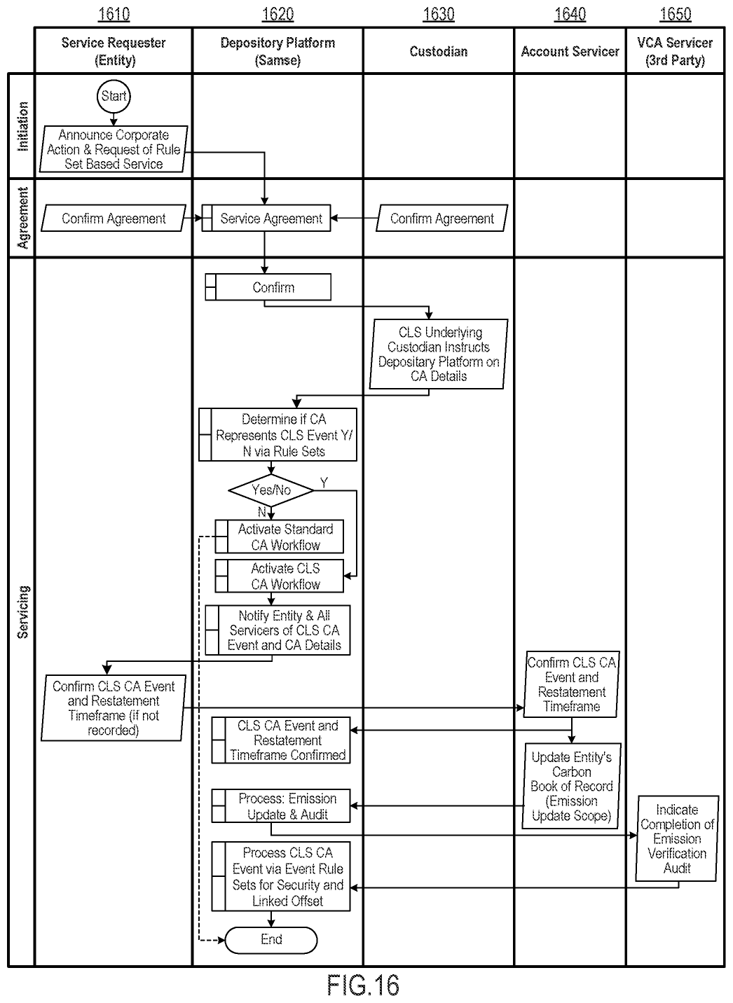

Embodiments of the disclosed technology are configured to implement one or more operations in FIG. 9 (and FIG. 16) as part of other methods and/or processes, as described in this document. For example, the depository platform 920 recording the settlement of the carbon offset amount and linking the carbon offset amount to the securities is similar to operation 530 in FIG. 5, which describes how a carbon neutral share is created.

The advantages of the distributed computing system, as compared to more centralized technologies in which required services and workflows for linked units can be created, include:
No central point of failure. The distributed computing system is not dependent upon an organization running a central computing platform with very high availability, and allows a mutual ownership model.
Transparency of data and processing. The distributed computing system is designed to allow high transparency of data and processing flows which are shared with every member of the distributed computing system network.
Audit trail and immutability. The design of the distributed computing system is widely distributed by ensuring that there is a full audit trail for all activities and an agreed-upon immutable record.
Integration. The distributed computing system provides a local node that acts as a gateway to the wider network and simplifies integration with members' own business applications via a graphical user interface (GUI).
Match of legacy strengths. The common perceived core strengths of a legacy, centralized platform are replicated in the distributed computing system by maintaining a single “golden” data copy for reference data, enforcement of market integrity, and regulatory and legal compliance.
Mirrors the decentralized governance model. The technological approach of the distributed computing system, which includes a mutually shared data store with permissions, embedded workflow compliance checks, and smart configured workflows, is similar to the network business model.
Disintermediation. The distributed computing system supports the continued move to the reduction of intermediaries required for end-to-end business processes, and provides enforceable trust between parties.

2.2 The Carbon Neutral Security (CNS) Ratio

In some embodiments, a carbon-link security includes a financial security and a carbon offset that is computed using a ratio based on the carbon footprint emissions and fundamentals of the underlying security issuer or specific security issuance. In an example, the ratio, which is referred to as the carbon neutral security (CNS) ratio, is calculated based on comparing the issuer's fundamentals and the issuer's carbon emissions footprint.

In an example, the CNS ratio required per security can be expressed in metric tons of carbon, and can be calculated as:

CNS ratio=C/N/S.

Herein, N represents the years until the company, entity, or project reaches its commitment of a carbon-neutral date, C represents carbon offset requirements across N years as determined by best practice workflows to verify, certify, and audit emissions and any acquired offsets (e.g., with all factors being measured using equivalent carbon metric tons for all GHG emissions), and S represents the units of the financial instrument being used.

In another example, the ratio can be used with a municipal revenue bond to construct a roadway a building, or even maintain said project, with the ratio being based on the emissions footprint versus the number of bonds issued. Herein, C is the carbon emissions or the carbon footprint requirements to build or maintain said project over N years, N is the duration of the bonds, and S is the units of bonds issued.

In yet another example, the ratio can be used with mortgage-backed securities, where C is the sum total of all carbon emissions or the carbon footprint of the underlying homes over N years, N is an average duration of the mortgages of the underlying homes, and S is units of issued mortgage-backed securities.

In yet another example, the ratio can be used with a general obligation bond, with the ratio being based on the municipality's entire carbon footprint versus issued bonds. Herein, C is the current carbon emissions or the carbon footprint of a municipality over N years, N is the duration of the bonds, and S is the units of bonds issued.

In yet another example, the ratio can be used with corporate bonds, with the ratio being based on a fraction of the bond issue total versus outstanding debt. Herein, the ratio is computed as:

CNS ratio=C/N/O.

Herein, C is the carbon emissions or the carbon footprint requirements to build or maintain said project over N years, N is the duration of the bonds, O is (notional value of bond issue/total outstanding debt)/S, and S is the units of bonds issued.

In yet another example, the ratio can be used with a general obligation bond, with the ratio being based on the municipality's entire carbon footprint versus a percentage of outstanding debt by the newly issued bonds being taken into consideration. Herein, C is the current carbon emissions or the carbon footprint of a municipality over N years, N is the duration of the bonds, O is the (notional value of bond issue/total outstanding debt)/S, and S is the units of bonds issued.

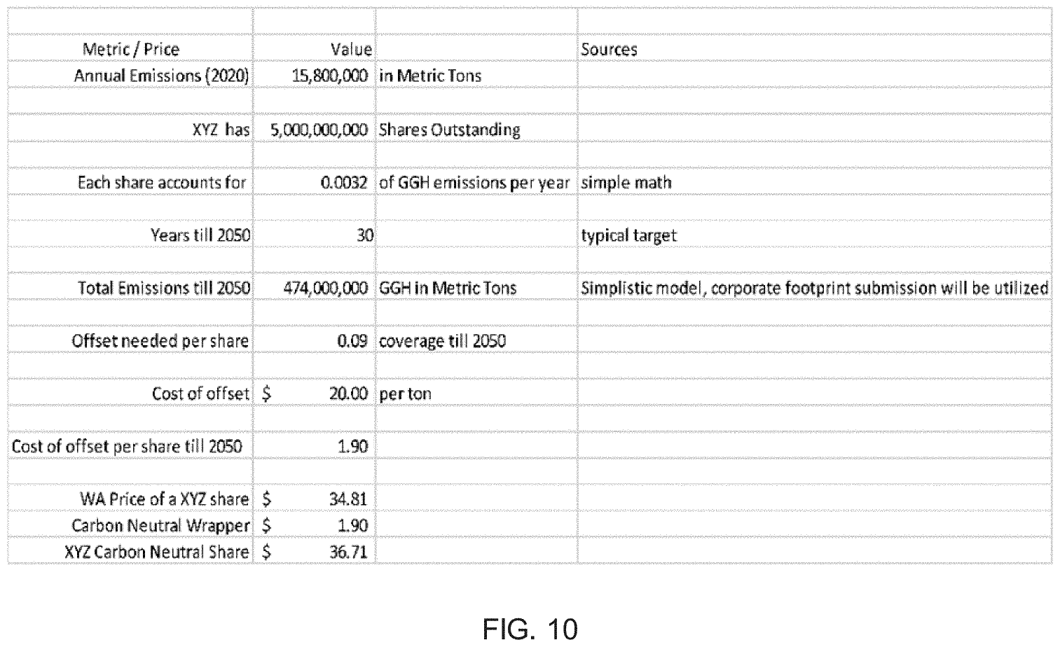

Furthermore, FIG. 10 shows an example calculation of a ratio using an issuer's fundamentals and carbon emission footprint for linking a carbon unit to a security.

In some embodiments, the CNS requirement is linked to a unit of the target financial instrument creating a carbon neutral position for the investor in that financial instrument. The investor, therefore, has a combined exposure to the financial instrument risk/return profile and carbon exposure. The company, entity, or project is allowed to use carbon offset towards its carbon neutral position but otherwise has no rights to the offset, which belong to the investor.

2.3 Standardization of Inputs for Carbon-Linked Securities

In some embodiments, the carbon footprint and/or carbon emissions are verified by one or more independent third parties prior to the CNS ratio being computed. It is advantageous to have multiple third parties certify or validate the carbon footprint and/or carbon emissions of the issuer to ensure that the correct information is being collected. However, this results in receiving not necessarily exactly the same information in multiple different formats.

Similarly, the carbon offset projects are received from one or more registries, each of which might have access to different carbon offset projects (e.g., a first company focuses on solar panel installations, a second company focuses on planting trees, a third company focuses on using more eco-friendly materials in the supply chain of certain industries, and so on). Having access to multiple registries advantageously enables the carbon-linked securities to diversify the risk of a specific project failing.

Embodiments of the disclosed are configured to standardize the received validations and certifications, as well as the carbon offset project information, in order to compute the CNS ratio and then create the carbon-linked security. In an example, the standardization includes identifying the subset of fields that is common across all received documents, and creating a template with those fields. These fields can be populated for each of the received documents. Other fields that may be identified differently are then processed to determine whether the same information is being reported differently across the documents and reports. However, if certain information is required, and not available from the received validations, certifications, and carbon offset project information, then the third-party is contacted for that information prior to is inclusion in the CNS ratio computation and carbon-linked security generation.

2.4 Examples of Adjusting a Carbon-Linked Security or Equity

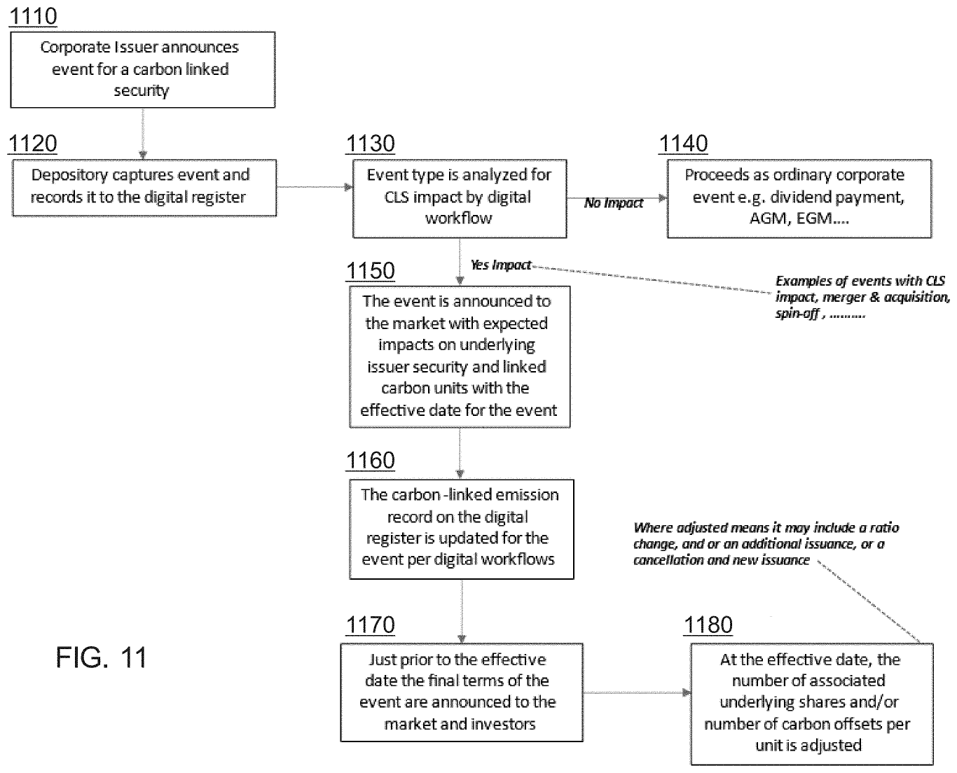

FIG. 11 shows a flowchart for an example method for adjusting a carbon-linked security following corporate actions using the ratio. As shown therein, the process begins with a corporate issuer announcing an event for a carbon-linked security 1110. The depository (e.g., depository platform 920 in FIGS. 9 and 1620 in FIG. 16) captures the event and records it to the digital register 1120. The digital workflow of the described embodiments analyzes the event for impacts to either the carbon footprint or the ratio (detailed in Section 2.2), or both 1130.

If there is no impact, the workflow proceeds as an ordinary corporate event/action 1140. However, if there is an impact, the event is announced to the market along with the expected impacts on the underlying securities and linked carbon units with the effective date of the event. In an example, the announcement includes an increase in the carbon offset amount per security corresponding to an acquisition, by the issuer, of another corporation with a larger carbon footprint. Alternatively, the acquisition could be of a large eco-friendly company with a low carbon footprint, which results in the announcement that the carbon offset amount per security has decreased. The carbon-linked emission record on the digital ledger is updated for the event per digital workflow 1160, and just prior to the effective date, the final terms of the event are announced to the market and investors 1170. Finally, at the effective date, the number of associated shares and/or number of carbon offsets per unit is adjusted.

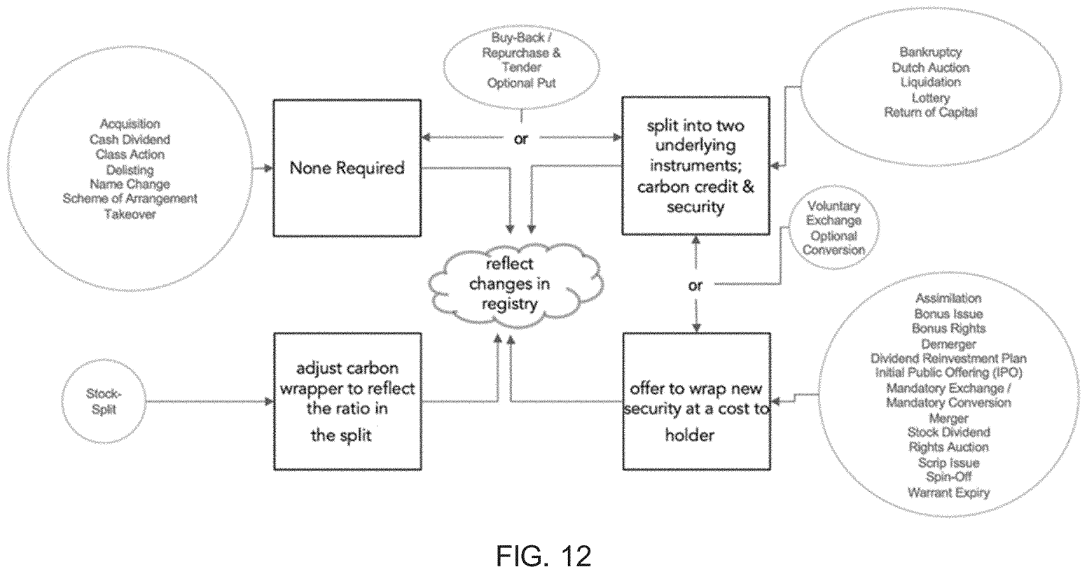

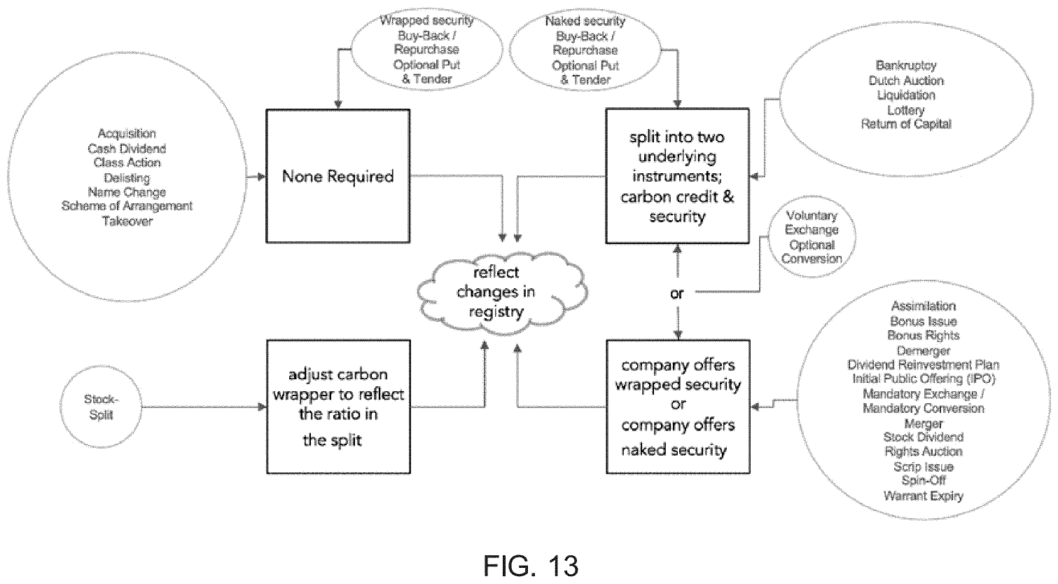

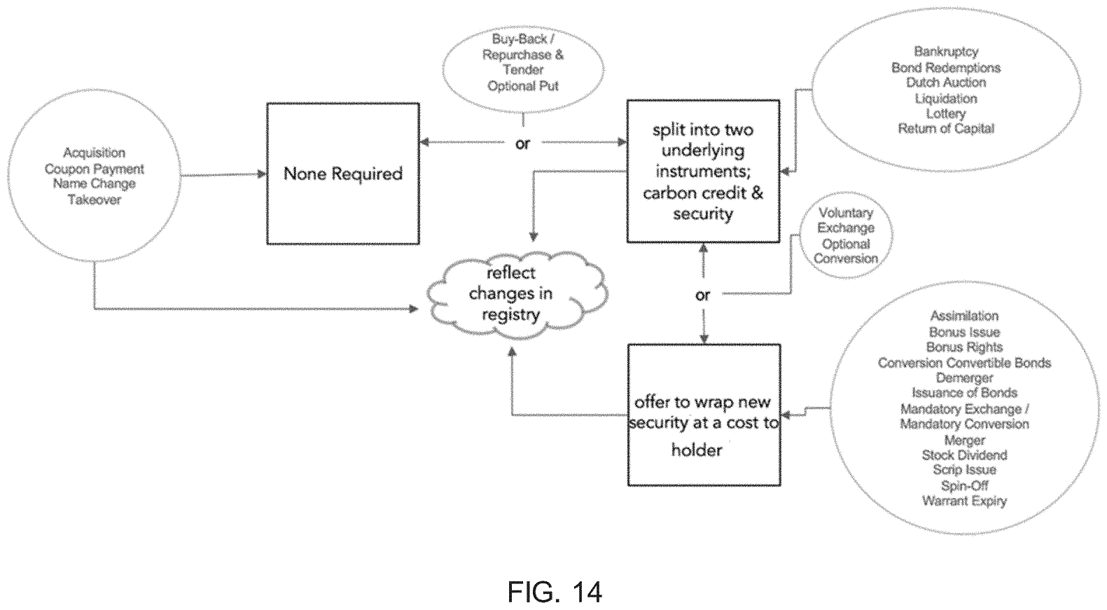

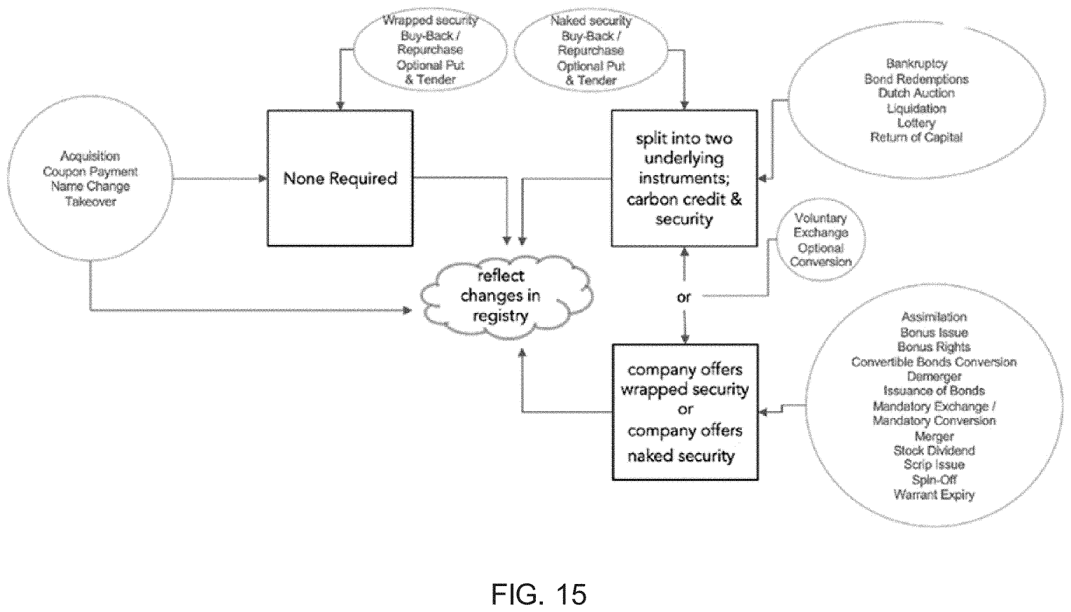

FIGS. 12-15 show process diagrams of example methods for the adjustment of various carbon-linked securities. FIG. 12 shows a process diagram of an example method for the adjustment of a third-party issued equity-based carbon-linked security, FIG. 13 shows a process diagram of an example method for the adjustment of a corporate bond-based carbon-linked security, FIG. 14 shows a process diagram of an example method for the adjustment of a third-party issued hybrid bond-based carbon-linked security, and FIG. 15 shows a process diagram of an example method for the adjustment of a corporate issued hybrid bond-based carbon-linked security. Each of these process diagrams enumerate the various corporate (or issuer) actions (or events), and illustrate the effect the particular corporate action has on the carbon-linked security and the fact that any change made to the carbon-linked security is reflected in the registry.

In an example, FIG. 12 shows that for a third-party issued equity-based carbon-linked security, an acquisition, cash dividend, class action, delisting, name change, scheme of arrangement, or takeover will result in no change to the underlying security. The various actions that can be taken include (1) splitting the carbon-linked security into two underlying instruments, i.e., the carbon credit and the security, (2) adjusting the carbon wrapper to reflect a change in the ratio due to a stock-split, and (3) offering to wrap a new security, offering a wrapped security, or offering a naked security. In the latter two cases, it is noted that changes in outstanding shares will cause a change in the carbon/credit ratio.

FIG. 16 shows an example operational systems process for administering a carbon-linked security following a corporate action. Therein, the various interactions between service requester 1610, the depository platform 1620, the custodian 1630, the account servicer 1640, and the third-party viability, capability and accountability (VCA) servicer 1650, which result in the adjustment of a carbon-linked security, are detailed. This example includes some features and/or operations that are similar to those shown in FIG. 9, and described above. At least some of these features and/or operations may not be separately described in this section.

As shown in FIG. 16, after “Initiation” and “Agreement” operations, the “Servicing” operation includes the depository platform 1620 notifying the entity and all services of the corporate action (event) and its details. The service requester 1610 confirms the corporate action and its timeframe, followed by the account servicer 1640 doing the same. The account servicer 1640 updates the carbon offset amount in the entity's carbon book of record, followed by the depository platform 1620 updating the carbon offset amount and performing an audit. The audit performed by the depository platform 1620 is verified by the third-party VCA servicer 1650.

In some embodiments, corporate action notifications are transmitted to the distributed computing system by a custodian associated with the issuer (or entity) using the Society for Worldwide Interbank Financial Telecommunication (SWIFT) protocol or any protocol that is compliant with ISO 20022. In other embodiments, the distributed computing system periodically checks the entity's website or the custodian's portal for any notifications. In yet another embodiments, the distributed computing system is configured to automatically crawl news sites (e.g., Associated Press, Reuters) to determine whether any corporate actions have occurred.

2.4.1 Adjusting a Carbon-Linked Security Using Smart Contracts

In some embodiments, a smart contract may be used to create, manage, and/or cancel a carbon-linked security. A smart contract on the blockchain (e.g., Bitcoin or Ethereum) is a contract that can be triggered by transactions on the blockchain system. Smart contracts can be defined in the form of code. Creating a smart contract includes the issuer sending a transaction containing the information to create a smart contract to the blockchain network, the blockchain network executing this transaction and generate a corresponding smart contract instance. A data field of the transaction that contains the creation of a smart contract can also store the logic and code of the smart contract. After the nodes of the blockchain network reach a consensus through a consensus mechanism, this smart contract is successfully created, and subsequent users can invoke this smart contract.

After the smart contract is created, a smart contract account corresponding to the smart contract appears on the blockchain and has an address. The smart contract codes and account storage will be stored in the smart contract account. The action of the smart contract is controlled by the contract codes, and the account storage of the smart contract saves the state of the smart contract. In other words, a smart contract causes a virtual account containing smart contract codes and account storage to be generated on the blockchain.

In a smart contract, multiple members can be declared, including state variables, functions, function modifiers, events, and so on. A state variable is a value that is permanently stored in the account storage field of the smart contract and is used to save the state of the smart contract. Generally, when a smart contract is deployed on the blockchain, the storage state corresponding to the state variables in the contract codes of the smart contract is either stored as plaintext or in an encrypted form.

The issuer can then send a transaction containing information about invoking a smart contract to the blockchain network, a node of the blockchain can execute the transaction and generate a corresponding smart contract instance. The data field also stores the method and parameter for invoking the smart contract. After the smart contract is invoked, the value of a parameter can change. Subsequently, a client can view the current value of the parameter through a blockchain node. The smart contract can be independently executed by each node in the blockchain network in a prescribed manner, and all execution records and data are stored on the blockchain, so after such transaction is completed, transaction credentials that cannot be tampered with and will not be lost are stored on the blockchain.

In some embodiments, the issuer can create a transaction for a smart contract that includes one or parameters associated with underlying security, one or more parameters associated with the carbon offset amount, and logic and code to performs various actions when the smart contract is invoked by a node on the blockchain. In an example, once the smart contract has been created, the logic and code is configured to periodically scan for notifications of corporate actions associated with the issuer (e.g., by crawling news sites or checking the webpage of the issuer). In another example, the smart contract receives the corporate action notification from the custodian of the issuer (similar to operation 1110 in FIG. 11).

Upon determining a corporate action has occurred, the logic and code is configured to determine whether the corporate action affects the ratio (similar to operation 1130 in FIG. 11). If it does, then the ratio is automatically recomputed, and the value of the carbon offset amount in the smart contract is updated (similar to operation 1180 in FIG. 11), and now visible (and available) to any node that invokes the contract. In an example, if the smart contract was invoked by a node prior to a corporate action that impacts the ratio, the logic and code is configured to update an instance of the smart contract if it has not been completed. Alternatively, the node that invoked the smart contract may have contracted not to update the ratio in that particular instance of the smart contract.

Similarly, the logic and code of the smart contract is configured to continually check for updates corresponding to the certifications and/or validations of the issuer's carbon footprint, as well as the certifications and/or validations of the carbon offset projects that underly the carbon offset amount. Both the issuer and the node on the blockchain that invoked the contract are able to change the values of the parameters or state variables, but each of these changes is performed in a transparent manner (e.g., visible to other nodes on the blockchain) so as to maintain the integrity of the carbon-linked security or equity.

### 3 Methods and Implementations of the Disclosed Technology

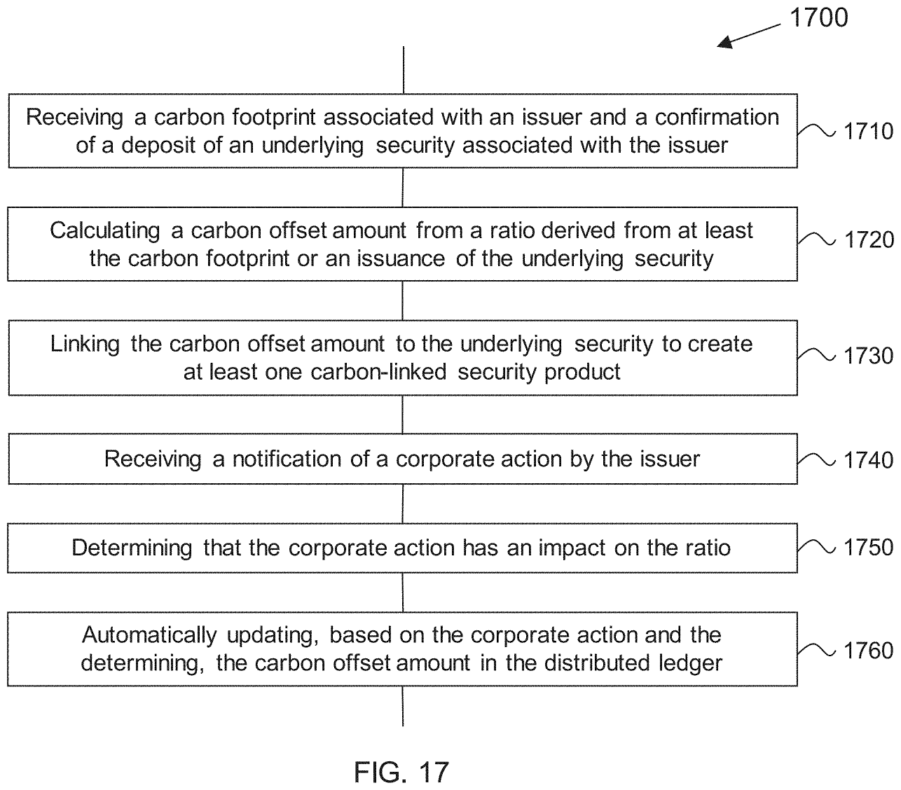

FIG. 17 is a flowchart of an example method 1700 for administering at least one carbon-linked security product. The method 1700 includes receiving a carbon footprint associated with an issuer and a confirmation of a deposit of an underlying security associated with the issuer (1710), calculating a carbon offset amount from a ratio derived from at least the carbon footprint or an issuance of the underlying security (1720), linking the carbon offset amount to the underlying security to create at least one carbon-linked security product (1730), receiving a notification of a corporate action by the issuer (1740), determining that the corporate action has an impact on the ratio (1750), and automatically updating, based on the corporate action and the determining, the carbon offset amount in the distributed ledger (1760).

The disclosed technology provides, inter alia, the following technical solutions:

A1. A method performed by one or more computer systems for the administering of at least one carbon-linked security product, comprising: one or more computer-readable storage mediums for storing computer executable instructions of: receiving issuance request for a carbon-linked security; receiving confirmation of a deposit of an underlying security or a basket of one or more carbon offset positions; deriving at least one carbon offset position based at least in part on fundamentals of an issuer of the underlying security and a carbon footprint of said issuer; linking the underlying security to the at least one carbon offset position to create the carbon-based security product; issuing the carbon-based security product; recording issuance of the carbon-based security product; receiving or updating a global emissions inventory of the issuer to reflect issuance of the carbon-linked security; periodically updating aspects of the carbon-linked security based on a set of monitored criteria; and receiving transfer and confirmation of ownership of the carbon-linked security; cancelling the carbon-linked security by returning the underlying security to the issuer and reallocating the at least one carbon offset position or.

A2. One or more computing systems of solution A1, wherein a request for issuance of carbon-linked security is received and recorded.

A3. One or more computing systems of solution A1, wherein a confirmation of deposit of a security or a basket of one or more carbon offset positions is received and recorded.

A4. One or more computing systems of solution A1, wherein a carbon offset position is derived based in part of fundamentals of an issuer of the underlying security and a carbon footprint and recorded.

A5. One or more computing systems of solution A1, wherein the underlying security and at least one carbon offset position is linked to create a carbon-linked security and recorded.

A6. One or more computing systems of solution A1, wherein a carbon-linked security is issued and recorded.

A7. One or more computing systems of solution A1, wherein global emissions inventory of the issuer is received and recorded.

A8. One or more computing systems of solution A1, wherein aspects of the carbon-linked security are monitored, updated, and recorded based on a set of monitored criteria.

A9. One or more computing systems of solution A1, wherein a carbon-linked security's ownership changes are received, confirmed, recorded.

A10. One or more computing systems of solution A1, wherein a carbon-linked security is cancelled and by returning the underlying security to the holder and reallocating the basket of one or more carbon offset positions.

A11. A method performed by one or more computing systems for the creation and calculation of a ratio of carbon offset baskets to underlying security based on an issuer's fundamental data and a representation of their carbon emissions footprint comprising: receiving security issuer's and issuance data; receiving underlying issuers carbon emissions data; receiving verification of issuers carbon data; calculating a ratio; monitoring issuer and security issue for changes; and updating ratio based on any changes in issuer carbon footprint, issuer corporate actions.

A12. One or more computing systems of solution A11, wherein security issuer's issuance data is received and recorded.

A13. One or more computing systems of solution A11, wherein underlying issuers carbon emissions (footprint) data is received

A14. One or more computing systems of solution A11, wherein verification of issuers carbon data is received and recorded.

A15. One or more computing systems of solution A11, wherein the carbon ratio is calculated and recorded.

A16. One or more computing systems of solution A11, wherein issuer and security issue is monitored for changes and recorded.

A17. One or more computing systems of solution A11, wherein ratio based on any changes in issuer carbon footprint, issuer corporate actions are updated and recorded.

A18. A method performed by one or more computing systems for adjusting the ratio used in the carbon-linked security as it pertains to changes due to corporate actions or fundamental changes to the issuer comprising: receiving corporate actions of an underlying issuer of an issued carbon-linked security; analyze corporate actions impact on a carbon-linked security; calculate impact on carbon-linked security; and adjust the number of associated underlying shares and/or number of carbon offsets per unit of security and notify and confirm designated entity of changes and/or cancel the carbon-linked security.

A19. One or more computing systems of solution A18, wherein corporate actions of an underlying issue is received from the network service and recorded.

A20. One or more computing systems of solution A18, wherein corporate actions are analyzed against pre-defined matrix and, as required, the associated underlying shares and/or number of carbon offsets are adjusted, or the carbon-linked security is canceled, and recorded.

A21. One or more computing systems of solution A18, wherein notification of the carbon-linked security impact is sent to the designated network service and recorded.

The disclosed technology further provides, inter alia, the following technical solutions:

B1. A method for administering at least one carbon-linked security product, comprising receiving a confirmation of a deposit of an underlying security associated with an issuer; receiving a carbon footprint associated with the issuer; calculating a carbon offset amount from a ratio derived from selected criteria including at least one of the carbon footprint associated with the issuer or an issuance of the underlying security; linking the carbon offset amount to the underlying security to create the at least one carbon-linked security product; recording the at least one carbon-linked security product in a distributed ledger; periodically receiving ongoing notifications of corporate actions by the issuer; filtering the ongoing notifications of corporate actions to identify a subset of corporate actions having an impact on at least the ratio; and automatically updating, for each corporate action in the subset of corporate actions, the carbon offset amount in the distributed ledger.

B2. The method of solution B1, wherein the distributed ledger is a blockchain-based ledger.

B3. The method of solution B1, wherein periodically receiving the ongoing notifications comprises receiving notifications from a custodian associated with the issuer.

B4. The method of solution B3, wherein the ongoing notifications are periodically received using a Society for Worldwide Interbank Financial Telecommunication (SWIFT) protocol.

B5. The method of solution B3, wherein the ongoing notifications are periodically received using a protocol that is compliant with ISO 20022.

B6. The method of solution B1, wherein periodically receiving the ongoing notifications comprises monitoring one or more online resources for the notifications of corporate actions by the issuer.

B7. The method of solution B1, further comprising receiving a validation or a certification of the carbon footprint, wherein the validation is generated by a third-party entity.

B8. The method of solution B1, wherein the ratio is further derived from a number of units of the underlying security and a number of years associated with the underlying security.

B9. The method of solution B8, wherein the issuance of the underlying security comprises an issuance of a bond, and wherein the number of years is a duration of the bond.

B10. The method of solution B8, wherein the underlying security is a mortgage-backed security, and wherein the number of years is an average duration of mortgages associated with one or more underlying homes in the mortgage-backed security.

B11. The method of solution B 1, wherein automatically updating the carbon offset amount comprises updating the ratio.

B12. The method of solution B11, wherein updating the ratio comprises increasing the ratio when the corporate actions include an acquisition by the issuer, an assimilation by the issuer, a merger by the issuer, or a merger by the issuer.

B13. The method of solution B11, wherein updating the ratio comprises decreasing the ratio when the corporate actions include a sale by the issuer, a change in behavior by the issuer, a stock split, or a de-merger by the issuer.

B14. The method of solution B1, wherein the carbon offset amount corresponds to one or more carbon offset projects.

B15. The method of solution B14, further comprising receiving a validation of each of the one or more carbon offset projects, wherein the validation is generated by a third-party entity.

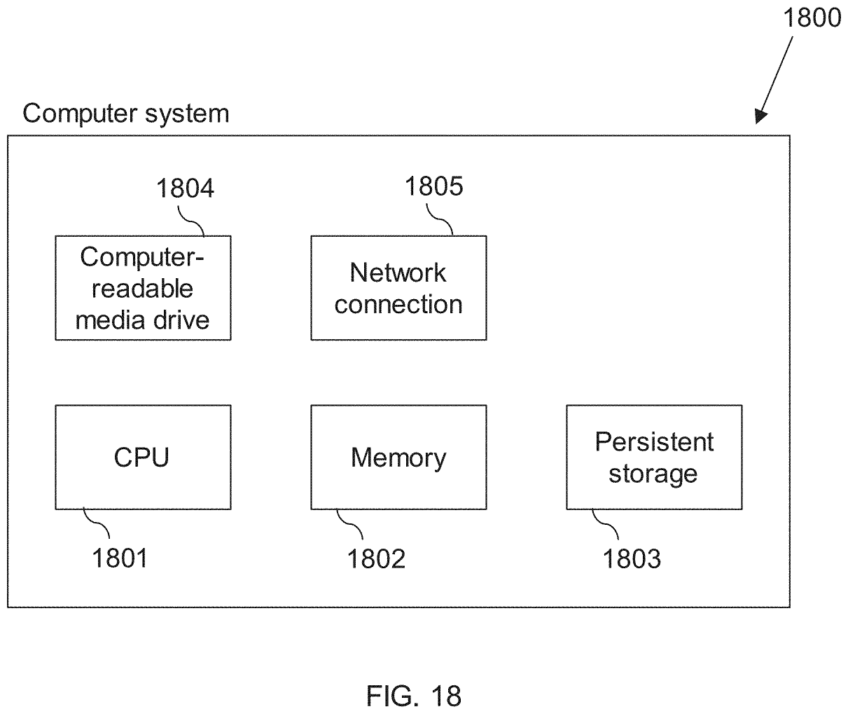

FIG. 18 is a block diagram showing some of the components typically incorporated in at least some of the computer systems and other devices on which the facility executes. These computer systems and devices 100 may include one or more central processing units (“CPUs”) 1801 for executing computer programs; a computer memory 1802 for storing programs and data—including data structures, database tables, other data tables, etc.—while they are being used; a persistent storage device 1803, such as a hard drive, for persistently storing programs and data; a computer-readable media drive 1804, such as a USB flash drive, for reading programs and data stored on a computer-readable medium; and a network connection 1805 for connecting the computer system to other computer systems, such as via the Internet, to exchange programs and/or data—including data structures. The terms “memory” and “computer-readable storage medium” include any combination of temporary and/or permanent storage, e.g., read-only memory (ROM) and writable memory (e.g., random access memory or RAM), writable nonvolatile memory such as flash memory, hard drives, removable media, magnetically or optically readable discs, nanotechnology memory, synthetic biological memory, and so forth, but do not include a propagating signal per se. In various embodiments, the facility can be accessed by any suitable user interface including Web services calls to suitable APIs. While computer systems configured as described above are typically used to support the operation of the facility, one of ordinary skill in the art will appreciate that the facility may be implemented using devices of various types and configurations, and having various components.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media suitable for storing computer program instructions and data include all forms of nonvolatile memory, media and memory devices, including, by way of example, semiconductor memory devices, e.g., EPROM, EEPROM, and flash memory devices. The processor and memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for administering at least one carbon-linked security product, comprising:
receiving a confirmation of a deposit of an underlying security associated with an issuer;
receiving a carbon footprint associated with the issuer;
calculating a carbon offset amount from a ratio derived from selected criteria including at least one of the carbon footprint associated with the issuer or an issuance of the underlying security;
linking the carbon offset amount to the underlying security to create the at least one carbon-linked security product;
recording the at least one carbon-linked security product in a distributed ledger;
periodically receiving ongoing notifications of corporate actions by the issuer;
filtering the ongoing notifications of corporate actions to identify a subset of corporate actions having an impact on at least the ratio; and
automatically updating, for each corporate action in the subset of corporate actions, the carbon offset amount in the distributed ledger.

2. The method of claim 1, wherein the distributed ledger is a blockchain-based ledger.

3. The method of claim 1, wherein periodically receiving the ongoing notifications comprises receiving notifications from a custodian associated with the issuer.

4. The method of claim 3, wherein the ongoing notifications are periodically received using a Society for Worldwide Interbank Financial Telecommunication (SWIFT) protocol.

5. The method of claim 3, wherein the ongoing notifications are periodically received using a protocol that is compliant with ISO 20022.

6. The method of claim 1, wherein periodically receiving the ongoing notifications comprises monitoring one or more online resources for the notifications of corporate actions by the issuer.

7. The method of claim 1, further comprising:
receiving a validation or a certification of the carbon footprint, wherein the validation is generated by a third-party entity.

8. The method of claim 1, wherein the ratio is further derived from a number of units of the underlying security and a number of years associated with the underlying security.

9. The method of claim 8, wherein the issuance of the underlying security comprises an issuance of a bond, and wherein the number of years is a duration of the bond.

10. The method of claim 8, wherein the underlying security is a mortgage-backed security, and wherein the number of years is an average duration of mortgages associated with one or more underlying homes in the mortgage-backed security.

11. The method of claim 1, wherein automatically updating the carbon offset amount comprises updating the ratio.

12. The method of claim 11, wherein updating the ratio comprises increasing the ratio when the corporate actions include an acquisition by the issuer, an assimilation by the issuer, a merger by the issuer, or a merger by the issuer.

13. The method of claim 11, wherein updating the ratio comprises decreasing the ratio when the corporate actions include a sale by the issuer, a change in behavior by the issuer, a stock split, or a de-merger by the issuer.

14. The method of claim 1, wherein the carbon offset amount corresponds to one or more carbon offset projects.

15. The method of claim 14, further comprising:
receiving a validation of each of the one or more carbon offset projects, wherein the validation is generated by a third-party entity.

16. An apparatus for administering at least one carbon-linked security product, comprising:
a processor; and
a memory coupled to the processor, the memory comprising instructions, the instructions when executed cause the processor to:
receive a confirmation of a deposit of an underlying security associated with an issuer;
receive a carbon footprint associated with the issuer;
calculate a carbon offset amount from a ratio derived from selected criteria including at least one of the carbon footprint associated with the issuer or an issuance of the underlying security;
link the carbon offset amount to the underlying security to create the at least one carbon-linked security product;
record the at least one carbon-linked security product in a distributed ledger;
periodically receive ongoing notifications of corporate actions by the issuer;
filter the ongoing notifications of corporate actions to identify a subset of corporate actions having an impact on at least the ratio; and
automatically update, for each corporate action in the subset of corporate actions, the carbon offset amount in the distributed ledger.
